(19) United States
(12) Patent Application Publication
(10) Pub. No.: US 2014/0156463 A1
(43) Pub. Date: Jun. 5, 2014

(54) SYSTEMS AND METHODS FOR PROVIDING MUSIC

(71) Applicant: Michael Benjamin HUI, Millbrae, CA (US)

(72) Inventor: Michael Benjamin HUI, Millbrae, CA (US)

(21) Appl. No.: 14/072,683

(22) Filed: Nov. 5, 2013

Related U.S. Application Data
(60) Provisional application No. 61/722,719, filed on Nov. 5, 2012.

(51) Int. Cl. G06Q 30/06

(52) U.S. Cl. CPC G06Q 30/0621
USPC 705/26.61

(57) ABSTRACT

A method for use in a process to provide music includes obtaining a first set of data that indicates a music preference of a first user, wherein the first user has a first music list, obtaining a second set of data that indicates a music preference of a second user, wherein the second user has a second music list, processing the first set of data and the second set of data, using a processor, to determine whether the first user and the second user have a similar music preference, and identifying a song in the second music list that is not in the first music list.

### RELATED APPLICATION DATA

This application claims priority to, and the benefit of, U.S. Provisional Patent Application No. 61/722,719, filed on Nov. 5, 2012, the entire disclosure of which is expressly incorporated by reference herein.

### FIELD

This application relates generally to systems and methods for providing music.

### BACKGROUND

With an abundance of digital music available on the web, the search for music can be tedious and extremely time consuming. With over a billion digital songs available on the web, the process of preview one song after another can be exhausting even for the most dedicated music fanatic.

With thousands of new songs release on the web daily, this process gets increasing more difficult and more antiquated with each passing day.

### SUMMARY

In accordance with some embodiments, a method for use in a process to provide music includes obtaining a first set of data that indicates a music preference of a first user, wherein the first user has a first music list, obtaining a second set of data that indicates a music preference of a second user, wherein the second user has a second music list, processing the first set of data and the second set of data, using a processor, to determine whether the first user and the second user have a similar music preference, and identifying a song in the second music list that is not in the first music list.

In accordance with other embodiments, a system for use in a process to provide music includes a processor configured for obtaining a first set of data that indicates a music preference of a first user, wherein the first user has a first music list, obtaining a second set of data that indicates a music preference of a second user, wherein the second user has a second music list, processing the first set of data and the second set of data to determine whether the first user and the second user have a similar music preference, and identifying a song in the second music list that is not in the first music list.

In accordance with other embodiments, a computer product having a non-transitory medium storing a set of instructions, an execution of which causes a process to be performed, the process includes obtaining a first set of data that indicates a music preference of a first user, wherein the first user has a first music list, obtaining a second set of data that indicates a music preference of a second user, wherein the second user has a second music list, processing the first set of data and the second set of data to determine whether the first user and the second user have a similar music preference, and identifying a song in the second music list that is not in the first music list.

In accordance with other embodiments, a method of providing music includes determining a first list of songs, selecting a song from the first list for recommendation to a user, receiving input from the user, the input indicating a preference of the user with respect to the selected song from the first list, modifying the first list of songs, using a processor, to obtain a second list of songs based at least in part on the received input, and selecting a song from the second list for recommendation to the user.

In accordance with other embodiments, a system for providing music includes a processor configured for determining a first list of songs, selecting a song from the first list for recommendation to a user, receiving input from the user, the input indicating a preference of the user with respect to the selected song from the first list, modifying the first list of songs to obtain a second list of songs based at least in part on the received input, and selecting a song from the second list for recommendation to the user.

In accordance with other embodiments, a computer product having a non-transitory medium storing a set of instructions, an execution of which causes a process to be performed, the process includes determining a first list of songs, selecting a song from the first list for recommendation to a user, receiving input from the user, the input indicating a preference of the user with respect to the selected song from the first list, modifying the first list of songs to obtain a second list of songs based at least in part on the received input, and selecting a song from the second list for recommendation to the user.

In accordance with other embodiments, a method of presenting music to a user includes displaying a first graphic in a device that is associated with a first piece of music, wherein the first piece of music is pre-selected for recommendation to the user based on user data stored in a system for the user, receiving an input from the user at the device, playing the first piece of music using the device in response to the input received from the user, obtaining feedback from the user regarding the first piece of music, and transmitting the feedback from the device to the system through a network for updating the user data.

In accordance with other embodiments, an apparatus for presenting music to a user includes a screen for displaying a first graphic that is associated with a first piece of music, wherein the first piece of music is pre-selected for recommendation to the user based on user data stored in a system for the user, an input device for receiving an input from the user, a speaker configured for playing the first piece of music in response to the input received from the user, and a processor configured for obtaining feedback from the user regarding the first piece of music, and generating a signal to transmit the feedback to the system through a network for updating the user data.

In accordance with other embodiments, a computer product having a non-transitory medium storing a set of instructions, an execution of which causes a process to be performed, the process includes displaying a first graphic in a device that is associated with a first piece of music, wherein the first piece of music is pre-selected for recommendation to the user based on user data stored in a system for the user, receiving an input from the user at the device, playing the first piece of music using the device in response to the input received from the user, obtaining feedback from the user regarding the first piece of music, and transmitting the feedback from the device to the system through a network for updating the user data.

In accordance with other embodiments, a method of determining a number of potential fans includes accessing a first list of fans for a first music provider, generating signal(s) for recommending a song from a second music provider to a subset of the fans in the first list, receiving feedback regarding the recommended song from the subset of the fans in the first list, based on the received feedback, determining, using a processor, a number of fans from the subset of the fans who provided positive feedback regarding the recommended song, and determining a number of potential fans for the second music provider based at least in part on the number of fans from the subset who provided positive feedback, and a total number of fans in the subset of the fans.

In accordance with other embodiments, a system for determining a number of potential fans includes a processor configured for: accessing a first list of fans for a first music provider; generating signal(s) for recommending a song from a second music provider to a subset of the fans in the first list; receiving feedback regarding the recommended song from the subset of the fans in the first list; based on the received feedback, determining a number of fans from the subset of the fans who provided positive feedback regarding the recommended song; and determining a number of potential fans for the second music provider based at least in part on the number of fans from the subset who provided positive feedback, and a total number of fans in the subset of the fans.

In accordance with other embodiments, a computer product includes a non-transitory medium storing a set of instructions, an execution of which causes a process for determining a number of potential fans to be performed, the process comprising accessing a first list of fans for a first music provider, generating signal(s) for recommending a song from a second music provider to a subset of the fans in the first list, receiving feedback regarding the recommended song from the subset of the fans in the first list, based on the received feedback, determining a number of fans from the subset of the fans who provided positive feedback regarding the recommended song, and determining a number of potential fans for the second music provider based at least in part on the number of fans from the subset who provided positive feedback, and a total number of fans in the subset of the fans.

Other and further aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a music network in accordance with some embodiments;

FIG. 2 illustrates a method of providing music in accordance with some embodiments;

FIG. 3A illustrates a user interface in accordance with some embodiments;

FIG. 3B illustrates another user interface in accordance with some embodiments;

FIG. 4 illustrates a method of obtaining user data in accordance with some embodiments;

FIG. 5 illustrates an example of how users with similar music preference may be determined in accordance with some embodiments;

FIG. 6 illustrates a technique of generating a list of recommended songs for a user in accordance with some embodiments;

FIG. 7A illustrates a user interface for allowing a user to play music from a saved list in accordance with some embodiments;

FIG. 7B illustrates another user interface for allowing a user to play music from a saved list in accordance with some embodiments;

FIGS. 8A-8C illustrates a user interface for allowing a user to search music in accordance with some embodiments;

FIG. 9 illustrates a user interface for displaying top songs in accordance with some embodiments;

FIGS. 10A-10I illustrate a technique for determining a number of potential fans in accordance with some embodiments;

FIG. 11A illustrates a user interface for allowing a user to share a song or to purchase a song;

FIG. 11B illustrates a user interface for allowing a user to select a number of individuals for sharing a song;

FIG. 12 illustrates a user interface for allowing a user to listen a song while also allowing a user to access promotional information associated with the song or the provider of the song; and

FIG. 13 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

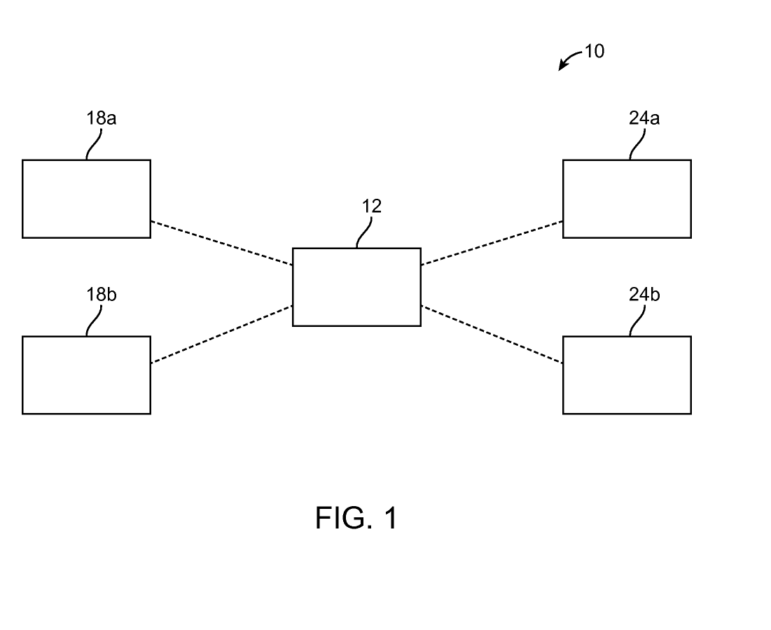

FIG. 1 illustrates a music network 10 that includes a system 12, one or more devices 18 used by end users, and one or more devices 24 used by music providers in accordance with some embodiments. In the illustrated embodiments, the system 12 is configured to receive music information from one or more music providers through the devices 24, and provide the music information to one or more end users who use the end user devices 18. The system 12 is configured to provide a network or a community in which different music providers can reach out to different potential listeners (users of the devices 18), and different listeners can discover new music provided by the music providers. Although only two end user devices 18 (devices 18a, 18b) are shown in the figure, in other embodiments, there may be more than two end user devices 18, or fewer than two end user devices 18 (i.e., one device 18) in the music network 10. Similarly, although only two music provider devices 24 (music provider devices 24a, 24b) are shown in the figure, in other embodiments, there may be more than two music provider devices 24, or fewer than two music provider devices 24 (i.e., one music provider device 24). In some embodiments, the end user device 18 may be any device that is capable of receiving and transmitting data, such as a mobile device (e.g., a smart phone, an iPhone, an emailing device, a Blackberry, an iPad, a tablet, a laptop, etc.), a desktop, a media device connected to a TV, etc. Also, the music provider device 24 may be any device that is capable of receiving and transmitting data, such as a mobile device (e.g., a smart phone, an iPhone, an emailing device, a Blackberry, an iPad, a tablet, a laptop, etc.), a desktop, a media device, etc. In other embodiments, the music provider device 24 may be any device that is capable of storing data (e.g., a music file and/or meta data associated with the music file), such as a thumb-drive, a disk, etc. The user of the music provider device 24 may be an artist, a music producer, a music writer, a performer, a music group, or any entity that is capable of providing music.

In some embodiments, the system 12 may be implemented using a computer. In such cases, the system 12 may include a processor and one or more non-transitory medium storing music files, meta data associated with the respective music files, and user data. In other embodiments, the system 12 may be a database. In such cases, the system 12 may include one or more processors, and one or more non-transitory medium storing music files, meta data associated with the respective music files, and user data. In some embodiments, the system 12 may have different media located at different geographical locations.

The music files and/or the meta data may be provided by different music provider devices 24. For example, in some embodiments, a music provider device 24 may transmit a music file and/or meta data associated with the music file to the system 12 through a network (e.g., the Internet) for storage at the medium of the system 12. In some embodiments, a music file may be a song or music piece that is stored in a “MP3” format, or another digital format, that allows the song or music to be played digitally in an electronic device. Also, by means of non-limiting examples, metal data associated with a music file may include one or a combination of music name, singer's name, player's name, composer's name, song writer's name, producer's name, date of release, genre, tempo, country of origin, lyrics, music notes, performance (e.g., concert) information, etc. In addition, in some embodiments, meta data stored in the system 12 may be generated by the system 12 in response to input by users of the different end user devices 18. By means of non-limiting examples, such meta data may include one or a combination of popularity, rating, number of users who like the piece, number of users who dislike the piece, number of users who saved the piece, number of users who bought the piece, etc.

In some embodiments, the system 12 may provide a user interface to the device 24 (for allowing a user of the device 24 to enter music file and/or meta data). For example, in some embodiments, in response to a request received from a device 24, the system 12 may transmit user interface data to the device 24, so that a user interface may be presented on the device 24 for receiving music file and/or meta data for the music file from the device 24. Alternatively, the device 24 may include an application for providing a user interface, which allows a user of the device 24 to enter music file and/or meta data. After the music file and/or meta data has been entered into the device 24, the device 24 then transmits the data through a network (e.g., the Internet) to the system 12 for storage. In other embodiments, the user interface for inputting music file and/or meta data may be provided by a combination of an application resided in the device 24 and data received from the system 12.

The user data may be provided by different user devices 18. For example, in some embodiments, a user device 18 may transmit user data to the system 12 through a network (e.g., the Internet) for storage at the medium of the system 12. By means of non-limiting examples, user data may include one or a combination of a user's name, a user identification, a user password, age, sex, ethnicity, address, music preference, etc. Also, a music preference may include one or more of a type of song preferred by a user, song period preferred by a user (e.g., the 80's, 90's, etc.), a rating for a piece of music, data indicating that the user likes a piece of music, data indicating that the user dislikes a piece of music, data indicating that the user has saved a music, data indicating that the user has bought the piece of music, etc.

In some embodiments, the system 12 may provide a user interface to a user device 18 (for allowing a user of the device 18 to enter user data). For example, in some embodiments, in response to a request received from a device 18, the system 12 may transmit user interface data to the device 18, so that a user interface may be presented on the device 18 for receiving input from a user of the device 18. Alternatively, the user device 18 may include an application for providing a user interface, which allows a user of the device 18 to enter user data. After the user data has been entered into the device 18, the device 18 then transmits the data through a network (e.g., the Internet) to the system 12. In other embodiments, the user interface for inputting user data may be provided by a combination of an application resided in the device 18 and data received from the system 12.

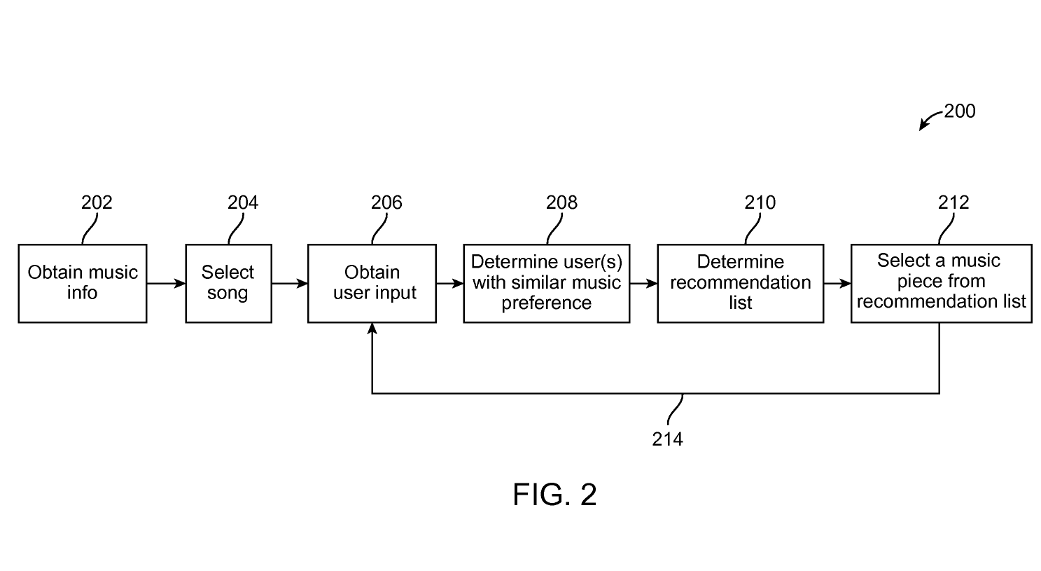

FIG. 2 illustrates a method 200 of providing music in accordance with some embodiments. The method 200 is performed by the system 12 of FIG. 1 in accordance with some embodiments. First, the system 12 obtains music file(s) and the associated meta data from one or more music provider devices 24 (Item 202). This may be accomplished by the system 12 receiving the music file(s) and meta data from the music provider device(s) 24 through a network (e.g., the Internet). Alternatively, the music file(s) and meta data may be saved in a non-transitory medium (e.g., a thumb drive, a disk, etc.), and is sent by the music provider to an administrator of the system 12, who will then upload the content in the non-transitory medium to the system 12. Overtime, the number of songs stored at the system 12 will build up, and the system 12 will have a list of songs for selection purpose.

Next, the system 12 selects certain songs from the list of songs for transmission to one or more end user devices 18 for presentation to the respective end users (Item 204). In some embodiments, the system 12 may be configured to select songs randomly for a user. In other embodiments, the system 12 may be configured to select songs based on user data input to the system 12 by the user. For example, in some embodiments, a user of the device 18 may input user data (e.g., age, sex, ethnicity, music preference, etc., of a user), and the device 18 then transmits such user data to the system 12. In such cases, the system 12 may select songs based on one or more of age, sex, ethnicity, music preference, etc., of the user of the device 18.

In some embodiments, the system 12 may present a selected song to the user of the device 18 by transmitting a name of the selected song for display at the device 18. The device 18 may include a user interface that displays the name of the song presented by the system 12, and that allows the user of the device 18 to select the song displayed at the device 18. In other embodiments, the system 12 may present a list of selected songs to the user of the device 18 by transmitting the list of selected songs for display at the device 18. The device 18 may include a user interface that displays the list of presented songs, and that allows the user of the device 18 to select any one of the songs displayed at the device 18. In some embodiments, a song presented by the system 12 may be automatically pushed to the device 18, in which case, the song may be automatically stored at the device 18. In other embodiments, a song presented by the system 12 may not be stored at the device 18. In such cases, the content of the song will be stored at the system 12, and when the user of the device 18 selects the name of the song presented by the system 12 at the device 18, the system 12 then transmits the content of the selected song to the device 18.

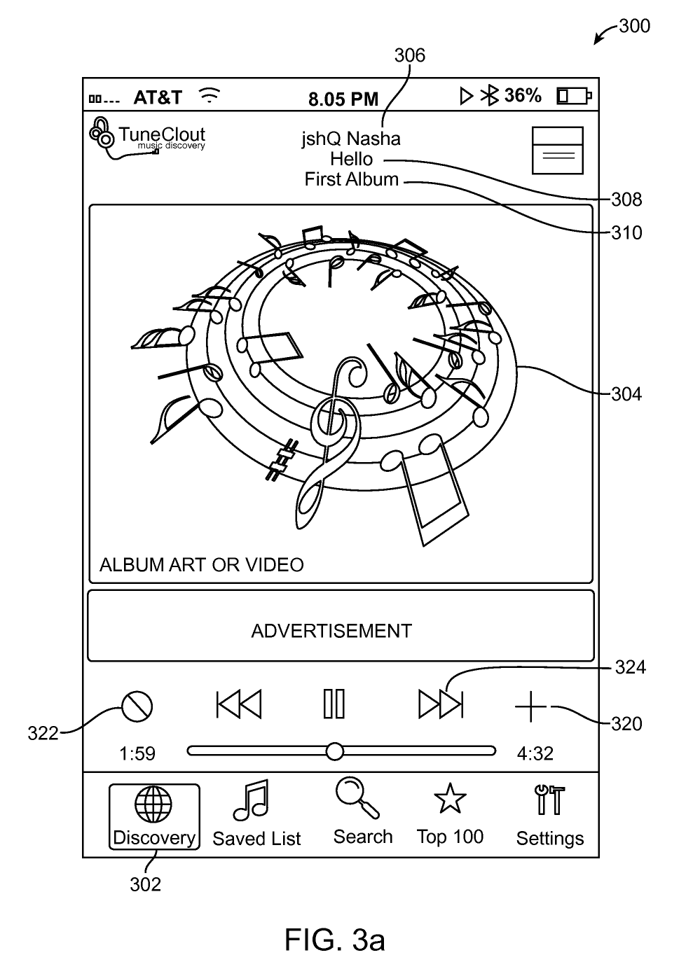

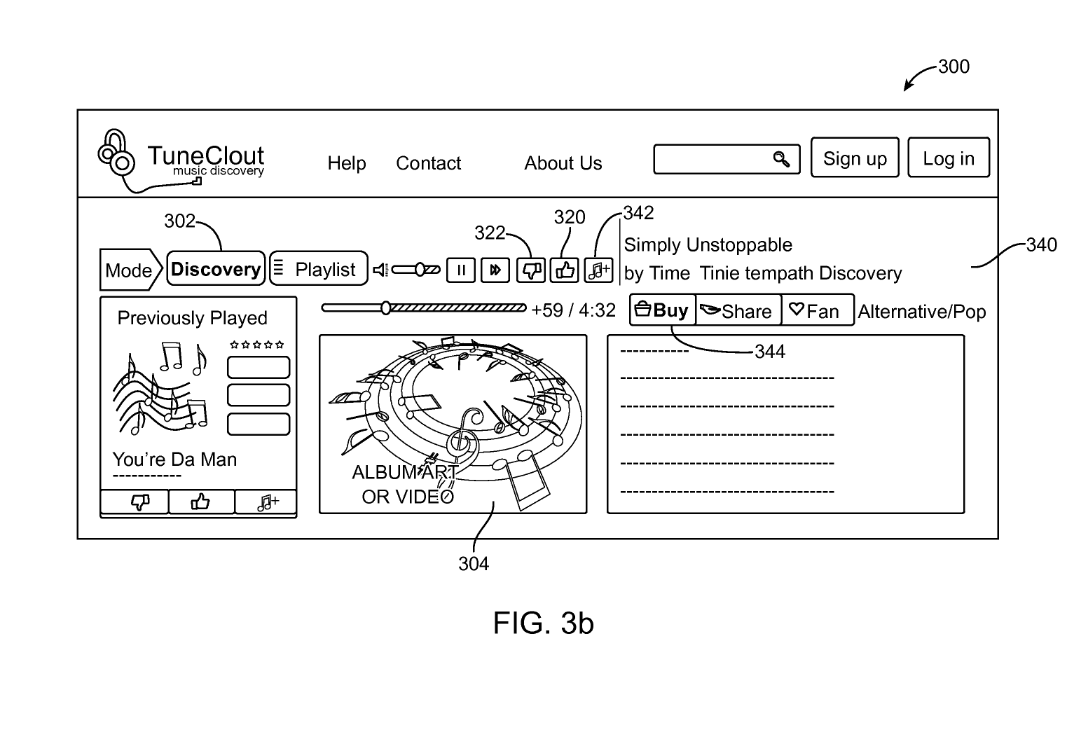

In some embodiments, the presenting of the songs by the system 12 to the device 18 may be performed during a “discovery mode”. In such cases, the device 18 may include a user interface that presents a discovery mode for allowing a user to discover new music. FIG. 3A illustrates an example of a user interface 300 that includes a “discovery” button 302 for allowing a user of the device 18 to discover new music in the discovery mode. During use, the user of the device 18 may select the discovery button 302 at the user interface 300 to enter into the discovery mode.

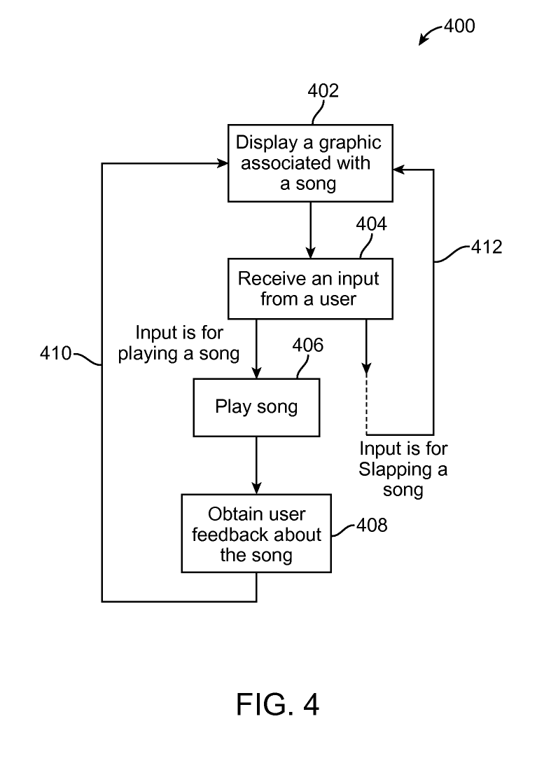

FIG. 4 illustrates a method 400 performed by the device 18 during the discovery mode in accordance with some embodiments. When in the discovery mode, the device 18 displays a graphic (e.g., the graphic 304, name of artist/music group 306, name of song 308, and/or album name 310, in FIG. 3A) associated with a song (pre-selected by the system 12) in response to the user pressing the discovery button 302. The user may use the interface at the device 18 to select whether to play the song, or to skip the song. If the user selects the song for playing (e.g., by pressing a play button), the device 18 then receives the input from the user (item 404), and plays the song for the user in response to the user input (Item 406). After a song is played at the device 18, the device 18 may ask the user for feedback about the song (Item 408). In some embodiments, the device 18 may display a “like” button or a “dislike” button for allowing the user to choose, thereby indicating whether the user likes the song just played or not. For examples, the “like” button 320 may be the “+” button in the user interface of FIG. 3A, and the “dislike” button 322 may be the “(\)” button in the user interface of FIG. 3A. Immediately presenting the “like” and “dislike” button at the user interface at the device 8 after the song is played, or while the song is being played, is advantageous because the user's impression on the song is still fresh. After the device 18 receives the input representing the user feedback, the input may then be transmitted by the device 18 to the system 12 for storage at the system 12. The device 18 then displays another graphic associated with another song from the list of songs pre-selected by the system 12, and the process repeats itself (see loopback arrow 410). On the other hand, if the user selects “skip”, then the device 18 will receive an input (in Item 404) from the user indicating that the user does not wish to listen to the recommended song. In such cases, the device 18 may display another graphic associated with another song (from the list of songs pre-selected by the system 12) at the device 18, and the process repeats itself (see loopback arrow 412). For example, the “skip” button 324 may be the “>>” button in the user interface of FIG. 3A.

In some embodiments, in the alternative to, or in addition to, presenting the “like” button 320 and “dislike” button 322 for the user to select, the user interface at the device 18 may also display graphic(s) 340 for allowing a user to enter a rating for a piece of music (e.g., in a scale of 1 to 5), a button 342 for allowing a user to save a music (e.g., in a favorite list), and/or a button 344 for allowing the user to purchase the piece of music (see FIG. 3B showing an alternative embodiment of the user interface 300). When a music piece has been saved by a user, the user may play the music piece on-demand. Alternatively, the saved music piece may be stored in the device 18 temporarily. In some embodiments, the system 12 and/or the device 18 may be configured to allow the user to play a saved music piece for only a number of prescribed times (e.g., 3 times, 5 times, 10 times, etc.). Also, in some embodiments, the numbers of times a user can play a saved piece of music may be different for different pieces of music, and may be arbitrarily set by the providers 24 of the respective music. After the user has played the saved music for the prescribed number of times, the device 18 may then display a graphic for asking whether the user would like to purchase the music. If the user purchases the music, the music may then be saved at the device 18 and/or the user may have permanent access to the piece of music. On the other hand, if the user decides not to purchase the music, then the system 12 and/or the device 18 may be configured to prevent the user from listening to the music until a purchase is made.

In other embodiments, instead of displaying a graphic of one song at a time, in response to the user pressing the discovery button 302, the device 18 may display a list (or a subset of the list) of the songs pre-selected by the system 12 for the user. If the user is interested in exploring any of the music in the displayed list, the user may select one of the songs from the list displayed at the device 18, and the device 18 will then play the song for the user. After the song is played, the device 18 may ask the user for feedback (e.g., whether the user likes or dislikes the song), and the user of the device 18 may then select another song from the pre-selected list for playing at the device 18. Because the complete list of songs stored at the system 12 will be constantly changing depending whether new songs are added, or old songs are removed, the system 12 may be configured to periodically update the list of songs pre-selected for a user of the device 18. Thus, in some embodiments, the list of songs recommended by the system 12 to the device 18 may change, depending on how frequent the system 12 updates the list of recommended songs and how often the user uses the discovery mode at the device 18. In some embodiments, the system 12 may be configured to update the list of songs pre-selected for a user of the device 18 every day, every other day, every week, every month, or at a time that is configurable by the user of the device 18.

It should be noted that the user interface 300 is not limited to the configuration shown in FIG. 3A, and that the user interface 300 may have other configurations in other embodiments. For example, as shown in FIG. 3B, in other embodiments, the user interface 300 may have a “thumb's up” button as the “like” button, and a “thumb's down” button as the “dislike” button. When in the discovery mode, the user may select the “add music” button to add a song to a playlist. The user may also select the “buy” button to purchase the music piece.

Returning to FIG. 2, after a song is played at the device 18, the system 12 may obtain user input about a song displayed in the device 18 (Item 206). As discussed, during the discover mode, the user of the device 18 may perform different actions using the interface at the device 18, such as skipping a song, playing a song, entering a feedback about a song (e.g., indicating whether the user like or dislike the song), saving a song, and/or purchasing a song. In some embodiments, during Item 206, the input from the actions by the user are transmitted from the device 18 to the system 12, and are stored as user data for the particular user. The user data collectively form a set of data that constitutes a listening profile of the user, and the set of user data for the user may be used to determine/represent a music preference for that user.

In some embodiments, multiple instances of the method 200 and the method 300 may be performed for different users. Accordingly, over time, the system 12 will have listening profiles for different users, wherein the listening profiles may be stored in one or more non-transitory media.

As shown in the method of FIG. 2, the system 12 next determines a number of users with similar music preference (Item 208). In some embodiments, two different users may be considered as having similar music preference if their listening profiles have similar attribute(s). For example, in some embodiments, two different users may be considered as having similar music preference when their respective listening profiles have data indicating that they commonly like one or more music pieces, data indicating that they commonly dislike one or more music pieces, data indicating that they commonly skipped one or more music pieces, data indicating that they commonly saved one or more music pieces, data indicating that they commonly purchased one or more music pieces, or any combination of the foregoing.

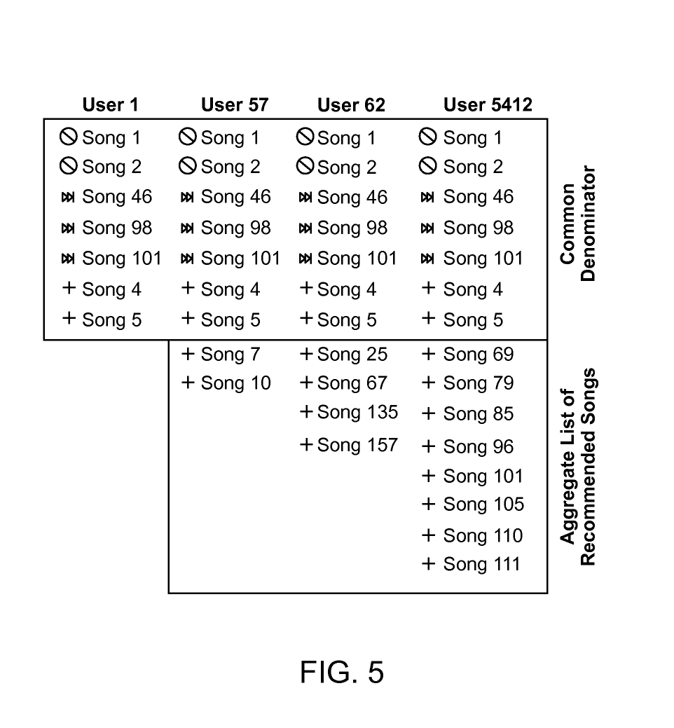

FIG. 5 illustrates an example of how different users may be determined as having similar music preference in accordance with some embodiments. As shown in the figure, user 1, user 57, user 62, and user 5412 may be considered as having similar music preference because they all dislike song 1 and song 2, they all saved songs 46, 98, and 101, and they all purchased songs 4 and 5. Although only four users are shown, in other embodiments, there may be more than four users or fewer than four users who have been determined by the system 12 as having similar music preference. In the illustrated embodiments, because the user data representing the different attributes of the respective users are stored at the system 12, the system 12 may be configured to process these user data to determine users with similar music preference. In some embodiments, the system 12 may provide a user interface for allowing a user of the system 12 (e.g., an administrator) to selectively prescribe different criteria for identifying users with similar music preference. For example, in some embodiments, the user of the system 12 may prescribe a minimum number N_{P} of common songs purchased (e.g., 2 songs), a minimum number N_{S} of common songs saved (e.g., 3 songs), a minimum number N_{L} of common songs liked (e.g., 5 songs), a minimum number N_{D} of common songs disliked (e.g., 2 songs), or a combination of the foregoing, to be meet by at least two users in order to consider the users as having a similar music preference. In such cases, based on input from the user of the system 12, the system 12 may determine two users as having similar music preference when their respective listening profiles indicate that the number of common songs purchased meets the required minimum number N_{P}, the number of common songs saved meets the required minimum number N_{S}, the number of common songs liked by the users meets the minimum number N_{L}, the number of common songs disliked by the users meets the minimum number N_{D}, or any of the combination of the foregoing.

In some embodiments, the system 12 may be configured to apply different weight factors for the different user data when determining whether different users have a similar music preference. For example, when a user plays a recommended music, that may be an indicator that the user is interested in trying out the piece of music, but may not necessarily indicate that the user likes or dislikes the music. Thus, the user data indicating that the user has played a piece of music may be given a relatively lower weight factor. On the other hand, when the user has played a piece of music, and has indicated that the user likes the music, it would be a better indicator that the user likes the music. When the user has saved a piece of music, it may be an even better indicator that the user likes the music. When a user purchased a piece of music, it may be a strong indicator indicating that the user likes the piece of music. Thus, in some embodiments, the system 12 may be configured to apply a first weight factor W1 for number of songs purchased, a second weight factor W2 for number of songs saved, a third weight factor W3 for number of songs liked by a user, wherein W1>W2>W3.

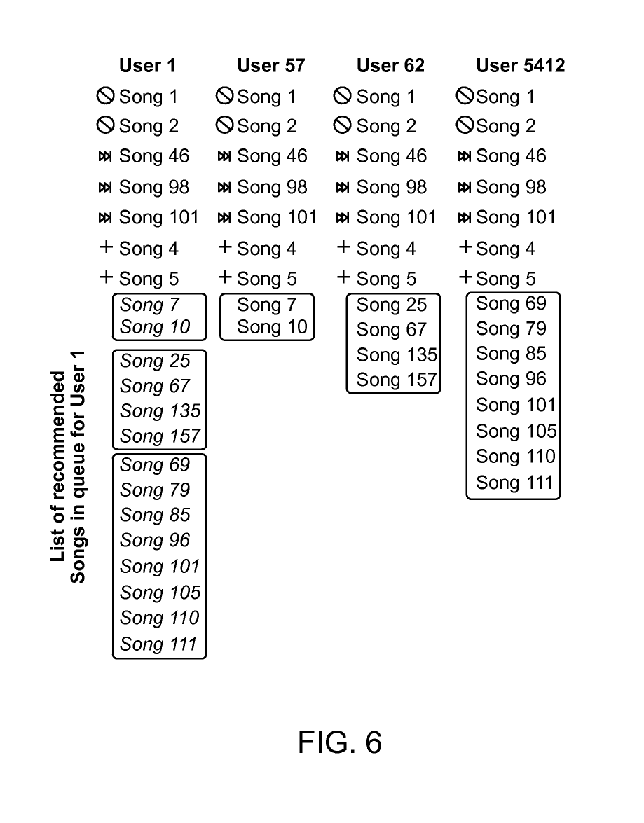

As shown in FIG. 2, the system 12 next aggregates a list of songs for recommendation to a user (Item 210). In the illustrated embodiments, the system 12 is configured to determine the list of songs for recommendation to a user based on a result from the act of Item 208. As shown in the example of FIG. 5, the system 12 has identified users 1, 57, 62, and 5412 has having similar music preference because these users' listening profiles have similar attributes. In the illustrated example, user 57 has purchased songs 7, 10 that are not on the purchase list of user 1. Similarly, user 62 has purchased songs 25, 67, 135, 157 that are not on the purchase list of user 1, and user 5412 has purchased songs 69, 79, 85, 96, 101, 105, 110, 111 that are also not on the purchase list of user 1. Thus, in some embodiments, when determining a list of recommended songs for a certain user, the system 12 identifies one or more purchased songs from other user(s) that are not in the purchase list of that user. Following the above example, when determining a list of recommended songs for user 1, the system 12 will identify songs 7, 10 (from user 57), songs 25, 67, 135, 157 (from user 62), and songs 69, 79, 85, 96, 101, 105, 110, 111 (from user 5412), and aggregate these songs into a recommendation list for user 1 (FIG. 6).

The system 12 may also similarly determine a list of recommended songs for user 57. Following the above example, the system 12 may identify that songs 25, 67, 135, 157 (from user 62) and songs 69, 79, 85, 96, 101, 105, 110, 111 (from user 5412) as songs that are not in the purchase list of user 57. Thus, the system 12 may aggregate these songs into a recommendation list for user 57.

The system 12 may also similarly determine a list of recommended songs for user 62. Following the above example, the system 12 may identify that songs 7, 10 (from user 57) and songs 69, 79, 85, 96, 101, 105, 110, 111 (from user 5412) as songs that are not in the purchase list of user 62. Thus, the system 12 may aggregate these songs into a recommendation list for user 62.

The system 12 may also similarly determine a list of recommended songs for user 5412. Following the above example, the system 12 may identify that songs 7, 10 (from user 57) and songs 25, 67, 135, 157 (from user 62) as songs that are not in the purchase list of user 5412. Thus, the system 12 may aggregate these songs into a recommendation list for user 5412.

In the above embodiments, songs purchased by different users who are determined by the system 12 as having similar music preference are aggregated into recommendation lists for the different users. Alternatively, or additionally, songs saved by different users who are determined by the system 12 as having similar music preference may be aggregated into recommendation lists for the different users.

Returning to FIG. 2, next the system 12 then recommends one or more songs from a recommendation list to a user (Item 212). In some embodiments, the system 12 may be configured to randomly select one or more songs from the recommendation list, and present the song(s) to the user. In other embodiments, the system 12 may be configured to select a song from the recommendation list that has been saved by the most number of users (e.g., the most number of users in the group of users that have been determined as having similar music preference, or the most number of users in the entire database). In further embodiments, the system 12 may be configured to select a song based on a time attribute of the song for recommendation to the user. For examples, the system 12 may select a newest song, or an oldest song, from the recommendation list for recommendation to the user. In further embodiments, the system 12 may be configured to select a song based on a rating of the songs in the recommendation list for recommendation to the user. For example, the system 12 may select the song with the highest rating, or the song with the highest number of “like” votes by different users, in the recommendation list for recommendation to the user. Other criteria may also be used in other embodiments for selecting a song from the recommendation list for recommendation to the user. Also, in other embodiments, the system 12 may select a song from the recommendation list based on a hierarchy of criteria. For example, in some embodiments, if the system 12 determines that there are two songs from the recommendation list that has been saved by the most number of users, then the system 12 may select one of the two songs that has the best rating for recommendation to the user.

After the system 12 has selected a song from the recommendation list for recommendation to the user, the system 12 then transmits information about the song to the device 18 to thereby recommend the song to the user of the device 18. By means of non-limiting examples, the information about the song may include one or a combination of a name of the song, a composer of the song, a singer of the song, a genre of the song, a picture associated with the song, and music data for the song. In some embodiments, the system 12 may be considered as recommending a song to a user when the system 12 transmits the information about the song to the device 18.

As shown in FIG. 2, the method 200 loops back to Item 206 (see arrow 214), in which the system 12 receives input from the user regarding the newly recommended song. Thus, Items 206-212 will be repeated. As the user listens to more songs, the amount of user data stored at the system 12 will increase. Accordingly, the listening profile for the user will be refined, and the recommendation list determined from Item 212 will be adjusted. Thus, as the method 200 repeats itself, the recommendation list from which song(s) to be selected for recommendation to a particular user will be changed, due to (1) a change in the listening profile for the particular user, (2) changes in the listening profiles for other users, and/or (3) a change in the music database at the system 12 because music providers may upload more songs or the system 12 may remove certain songs.

In some embodiments, songs disliked by a user, or skipped by a user for a number of times are no longer included in the recommendation list for the user. For example, if the system 12 receives an input from the device 18 for a particular user that indicates that the user dislikes a particular song, the system 12 then removes that song from the recommendation list for that particular user. Similarly, if the system 12 receives input from the device 18 for a particular user that indicates that the user skipped a particular song for a number of times, the system 12 then removes that song from the recommendation list for that particular user.

As illustrated in the above embodiments, the system 12 is configured to recommend to a user songs purchased or saved by other users that have similar listening profiles as that user. Such technique is advantageous because users who commonly like a number of songs are more likely to have additional song(s) that they also commonly like. Also, such technique obviates the need to perform complex analysis of individual's listening profile to determine a recommended song for the individual, because other user's listening profile already provides a guide for recommending songs to the individual.

Also, as illustrated in the above embodiments, the music player interface at the device 18 is a hybrid player that allows music discovery and on-demand music. In particular, the discovery mode of the interface functions as both a polling system to collect user data from the user, as well as a portal for introducing music to the user. The playlist mode allows the user to play music (e.g., on demand music). In some embodiments, the music player interface at the device 18 may be configured to have a look and feel of a radio. In such cases, the music player interface functions as an adaptive radio because the songs that are recommended and/or played for the user are “adapted” to suit the listening profile of that user.

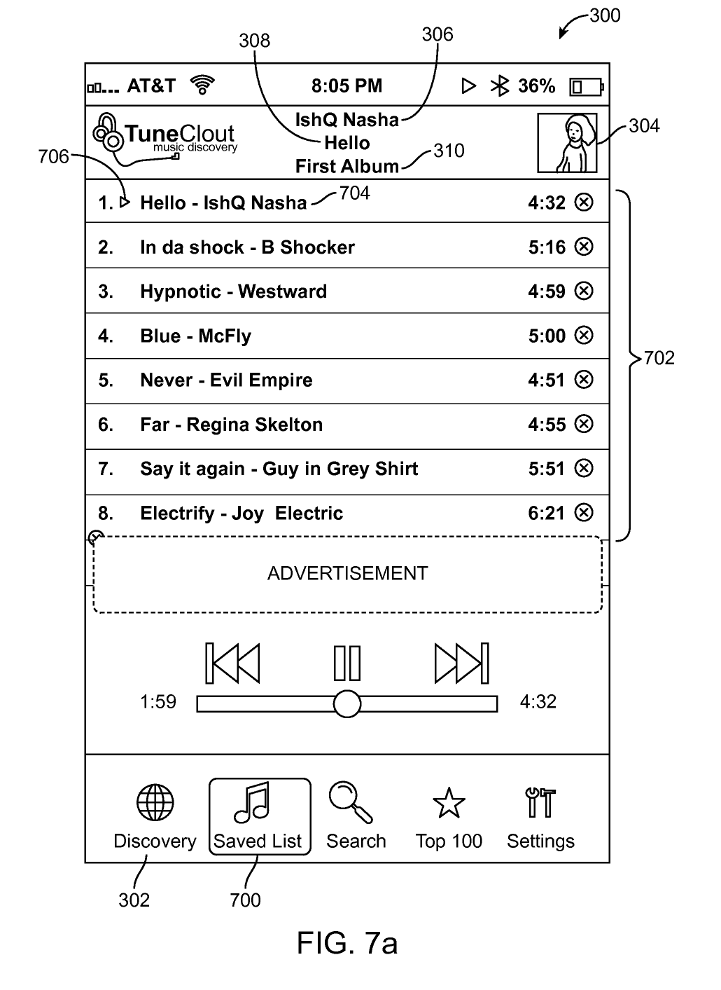

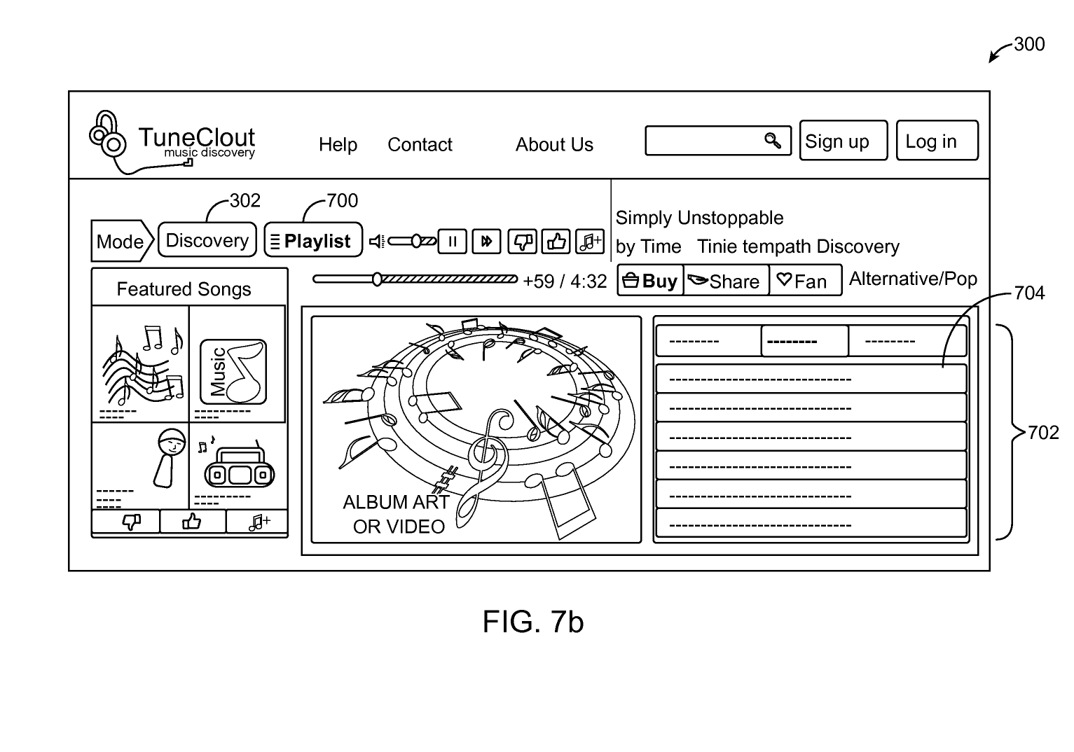

In some embodiments, the user interface 300 at the device 18 may include a “saved list” button 700, which allows a user of the device 18 to view a list 702 of the saved music pieces (FIG. 7A). During use, the user of the device 18 may press the button 700. In response to the user action, the device 18 displays the list 702 of saved music. The user may select the name 704 of one of the music pieces by pressing the name identifier. In response to this user action, the device 18 may then plays the music piece that corresponds with the user selection. As shown in the figure, the user interface 300 also includes a “play” identifier 706 to indicate the music piece that has been selected and is currently playing.

The user interface 300 may have other configurations in other embodiments when displaying a playlist. For example, in other embodiments, the user interface 300 may have the configuration shown in FIG. 7B when displaying a playlist. The user interface 300 of FIG. 7B is similar to that shown in FIG. 3B, except that when the playlist is displayed, the “add music” button and the “buy” button are not displayed.

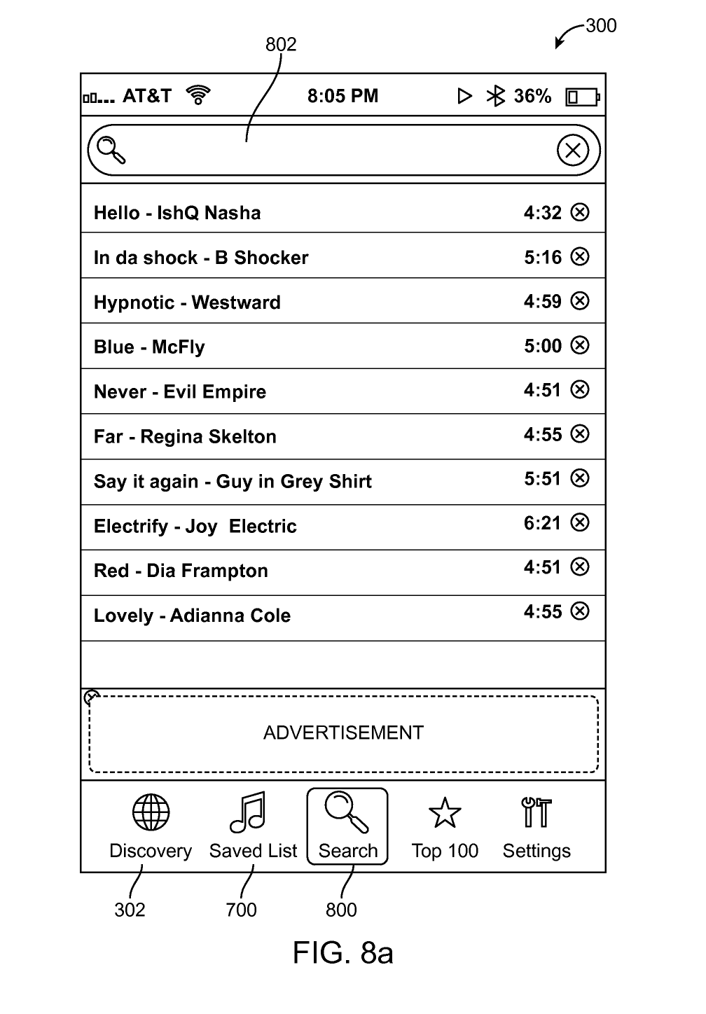

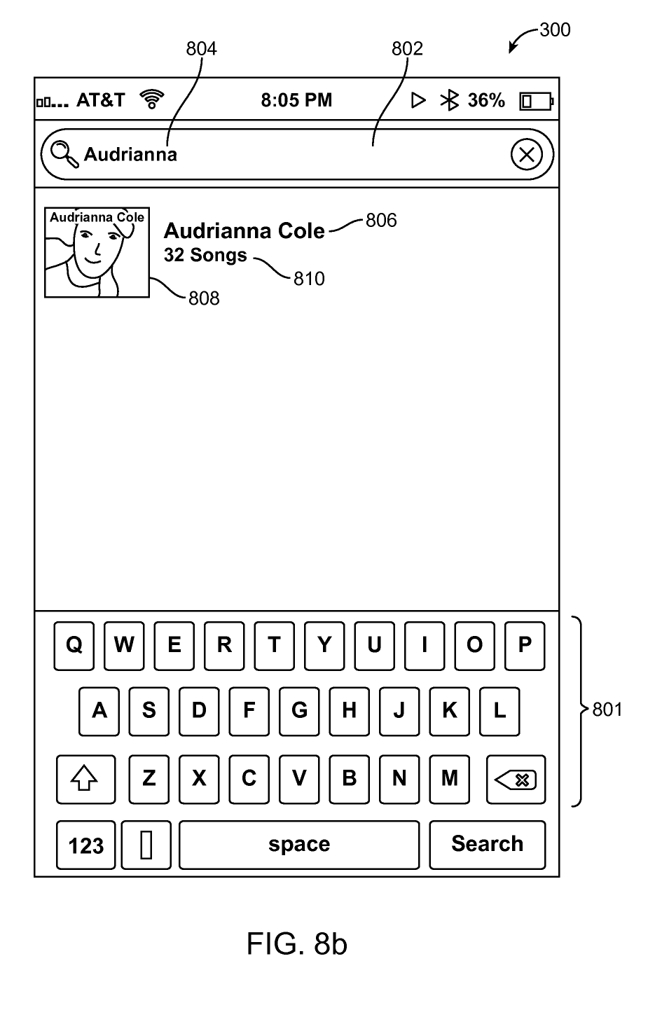

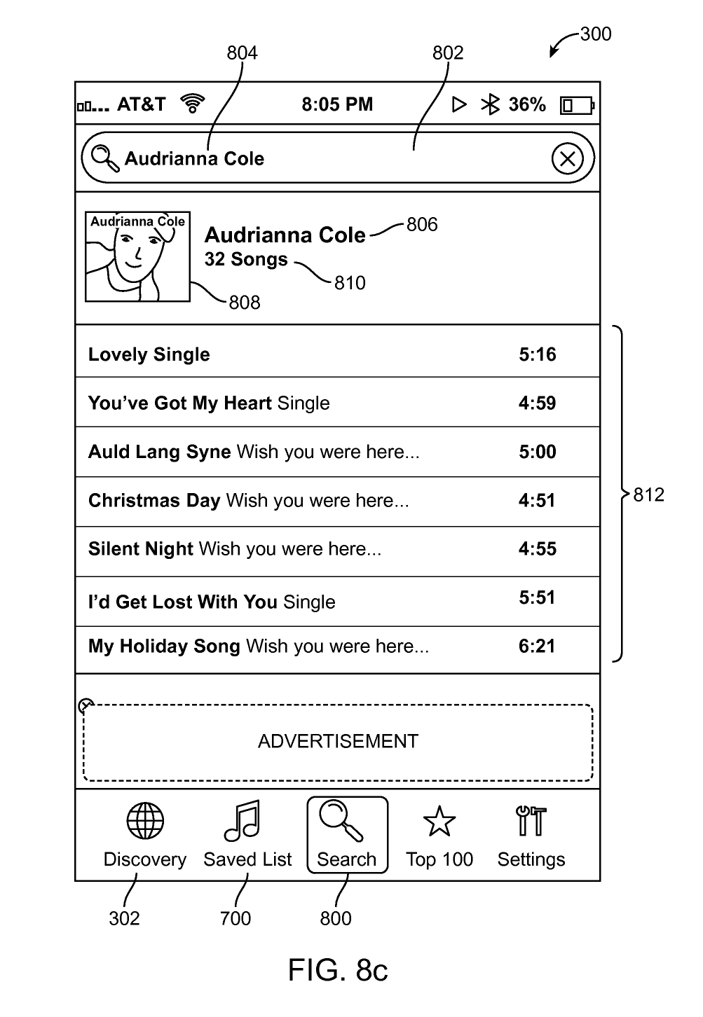

Also, in some embodiments, the user interface 300 at the device 18 may include a “search” button 800 for allowing a user to search for a particular music piece (FIG. 8A). During use, the user of the device 18 may press the button 800. In response to the user action, the device 18 displays an input field 802 for allowing the user to input search term(s). The user may press the search field 802, and in response to such action, the device 18 may displays a keyboard 801 for allowing the user to type the search term(s). In the illustrated embodiments shown in FIG. 8B, the user has typed “Audrianna”, and has pressed the “search” button 800. In response to these actions, the device 18 transmits the search criteria to the system 12 through a network (e.g., the Internet). The system 12 receives the search criteria, and searches its record to identify all songs or artist's names that meet the search criteria. When a search result has been obtained, the system 12 then transmits the search result to the device 18 through the network (e.g., the Internet). The device 18 receives the search result, and displays it on the screen. In the illustrated embodiments, the system 12 has determined that the artist's name “Audrianna Cole” is a match, and such artist has a total of 32 songs in the database. The system 12 transmits such information to the device 18, which displays them (the artist's name 806, a graphic for the artist 808, number of songs 810) in the screen. If the user of the device 18 determines that this is a correct search result, the user may select the search result (e.g., by pressing the artist's name 806, the graphic 808, or the number of songs 810). In response, the device 18 may transmit a request to the system 12 to retrieve the list of songs. The system 12 then transmits the list of songs from its database to the device 18, and the device 18 then displays the list 812 of songs in the user interface (FIG. 8C). The user may select one of the songs in the list 812 to thereby play the selected song.

In some embodiments, when the user selects the “search” button 800, the device 18 may ask the user whether the search is to be performed to look up music in the saved list, in the purchased list, or in the database of the system 12. If the user indicates that the search is to look up info at the database of the system 12, then the device 18 will communicate with the system 12 to retrieve the requested information, as discussed with reference to FIGS. 8A-8C. If the user indicates that the search is to look up music piece from a list of saved music, and if the saved music are stored in the device 18, then the device 18 will look up the requested information from the non-transitory medium in the device 18, and displays the search result at the device 18 for the user. Similarly, if the user indicates that the search is to look up music from a list of purchased music, and if the purchased music are stored in the device 18, then the device 18 will look up the requested information from the non-transitory medium in the device 18, and displays the search result at the device 18 for the user. Alternatively, the saved music and/or the purchased music may be stored at the system 12. In such cases, the device 18 will communicate with the system 12 to retrieve the requested information.

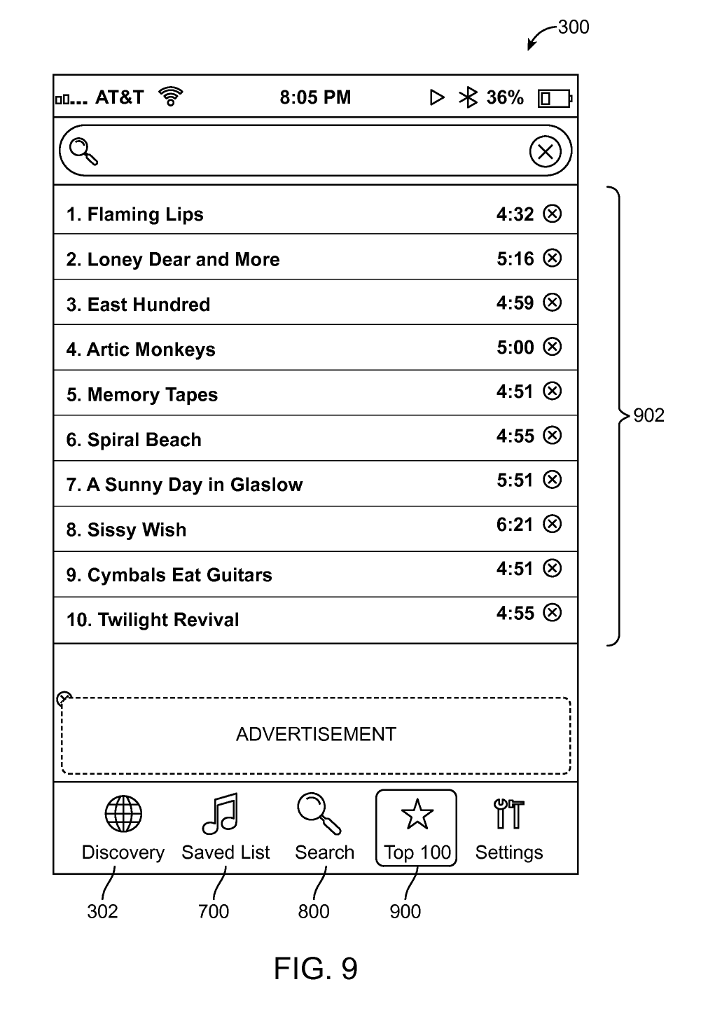

In one or more embodiments, the user interface 300 may also include a button 900 for allowing a user of the device 18 to view top music (FIG. 9). In the illustrated embodiments, the button 900 is a “top 100” button. When the user of the device 18 selects the button 900, the device 18 then transmits a request to the system 12 to obtain the top 100 songs. The system 12 looks up the requested information at its database, and transmits the query result to the device 18 for display at the device 18. As shown in the figure, the device 18 displays a list 902 of songs that has the highest rating. In some embodiments, when the button 900 is selected, the device 18 may ask the user to enter additional criteria, such as music category (e.g., hip hop, classical, opera, rap, etc.), for which the top songs are to be displayed.

In some embodiments, the system 12 may provide feedback to the devices 24 used by the different music providers so that they can track the performance of their music in real time and through periodic reports (e.g., weekly reports). In one implementation, an artist may enroll his/her songs to appear on the discovery radio as provided by the system 12 to the different devices 18. The discovery algorithm calculates which listener profiles best match the respective enrolled songs. The enrolled songs are then introduced to users with listening profiles that are best suited. This may be accomplished through the discovery mode on the player interface, as discussed. In some embodiments, when a music piece has been recommended to a user, the system 12 may transmit a message to the device 24 to inform the music provider of that music piece. Also, in some embodiments, when the system 12 receives feedback from a user of the device 18 regarding a particular piece of music, the system 12 may also transmit such user feedback to the device 24, so that the music provider of that particular piece of music can have real time feedback from a listener. Alternatively, the feedback may not be real time, and may occur at a later time. In addition, the system 12 may also transmit information regarding the user to the device 24, so that the music provider will have the information regarding its listeners. Furthermore, the system 12 may also be configured to periodically generate reports for a particular music provider, and transmit such reports to the device 24 through a network (e.g., the Internet). By means of non-limiting examples, the report may include information such as, (1) number of listeners who played a song, the number of times played, and/or information (e.g., user IDs, names, addresses, sex, ages, ethnicities, income levels, etc.) regarding these listeners, (2) numbers of listeners who liked a song and/or information regarding these listeners, (3) numbers of listeners who disliked a song and/or information regarding these listeners, (4) numbers of listeners who saved a song and/or information regarding these listeners, (5) numbers of listeners who purchased a song and/or information regarding these listeners, or any combination of the foregoing. In some cases, the report may also include progress charts to see how fast the fan base of a particular music piece is growing.

In some embodiments, the system 12 may be configured to use the user data from the listening profiles of different users to determine a compilation of music pieces. For example, the system 12 may identify ten pieces (or any of other prescribed numbers) of music that have been all commonly saved or purchased by a prescribed number of users, wherein the ten pieces of music may be provided by different music providers. The prescribed number of users may be arbitrarily set (e.g., using a user interface associated with the system 12), or may be set as the highest number of users. In such cases, the system 12 may provide this data (compilation data) that identifies the ten pieces of music to the respective music providers to inform these music providers that these music pieces will be good candidates for a compilation album. In some embodiments, the system 12 may provide the compilation data by transmitting the compilation data through a network (e.g., the Internet) to the different devices 24 used by the different music providers. Such feature will allow an artist to team up with other artists to create an album comprised of many other artists to create a product that could have high appeal to consumers. Alternatively, or additionally, the music providers may use the information from the compilation data provided by the system 12 to identify other artist(s) that may be good candidate(s) for a compilation live event. Thus, the information in the compilation data may also be considered promotional data. In other embodiments, the system 12 may separately provide compilation data and promotional data, as separate bundled groups of information. The compilation data and promotional data may have some common information, such as list of artists that may be good candidates for partnership projects. The compilation data and promotional data may also have different information. For example, in some embodiments, the promotional data may include additional information, such as date of live performance, contact info about the live performance, etc., of the different artists.

In one or more embodiments described herein, a user interface (e.g., the user interface at the device 18, at the system 12, or at the device 24) may be implemented using hardware, software, or combination of both. For example, in some embodiments, the user interface at the device 18 may be implemented by a processor at the device 18 running an application stored at the device 18. Alternatively, the user interface at the device 18 may be provided by the system 12, in which cases, a processor in the system 12 running an application may transmit data (e.g., content data, graphic data, etc.) for the interface for display at the device 18. In further embodiments, the user interface at the device 18 may be provided by both the system 12 and the device 18.

Similarly, in some embodiments, the user interface at the device 24 for the music provider may be implemented by a processor at the device 24 running an application stored at the device 24. Alternatively, the user interface at the device 24 may be provided by the system 12, in which cases, a processor in the system 12 running an application may transmit data (e.g., content data, graphic data, etc.) for the interface for display at the device 24. In further embodiments, the user interface at the device 24 may be provided by both the system 12 and the device 24.

Also, in one or more embodiments described herein, one or more of the actions described with reference to Items 202, 204, 206, 208, 210, 212 in the method 200, and Items 402, 404, 406, 408 in the method 400, may be performed by one or more processors executing respective instructions stored in one or more non-transitory media. If multiple processors are involved, the processors may be components of the system 12, components of the device 18, or components of both. Also, in some embodiments, the processors may be processing components that are part of a processor (or processing system). Thus, as used in this specification, the term “processor” or a similar term, such as “processing system”, may refer to one or more processing components, such as one or more processors.

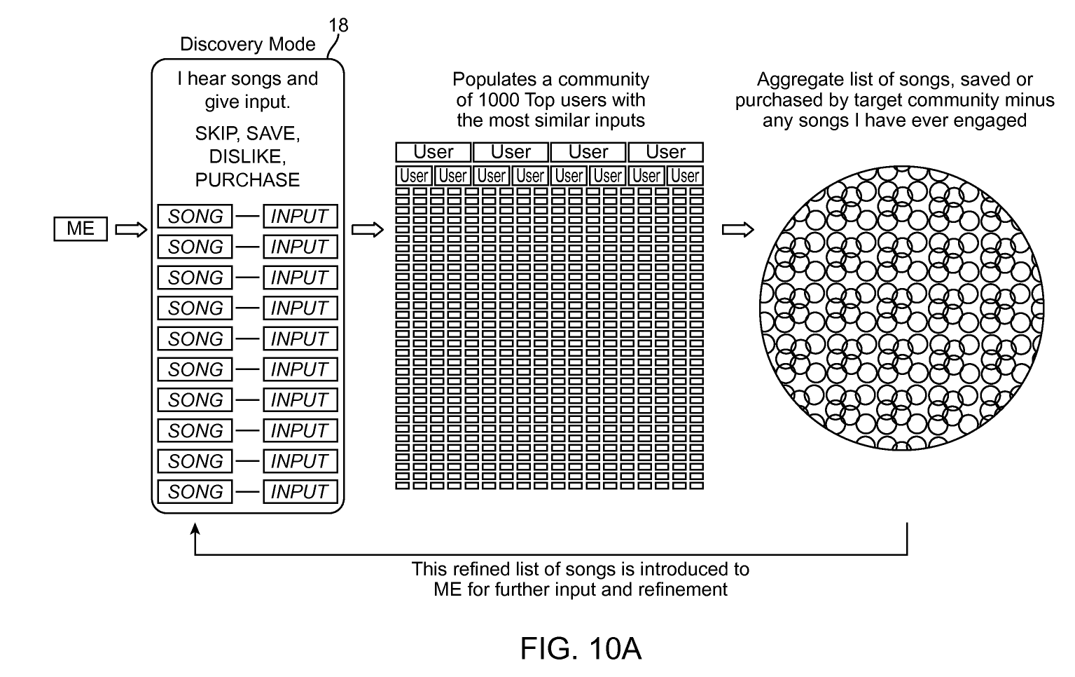

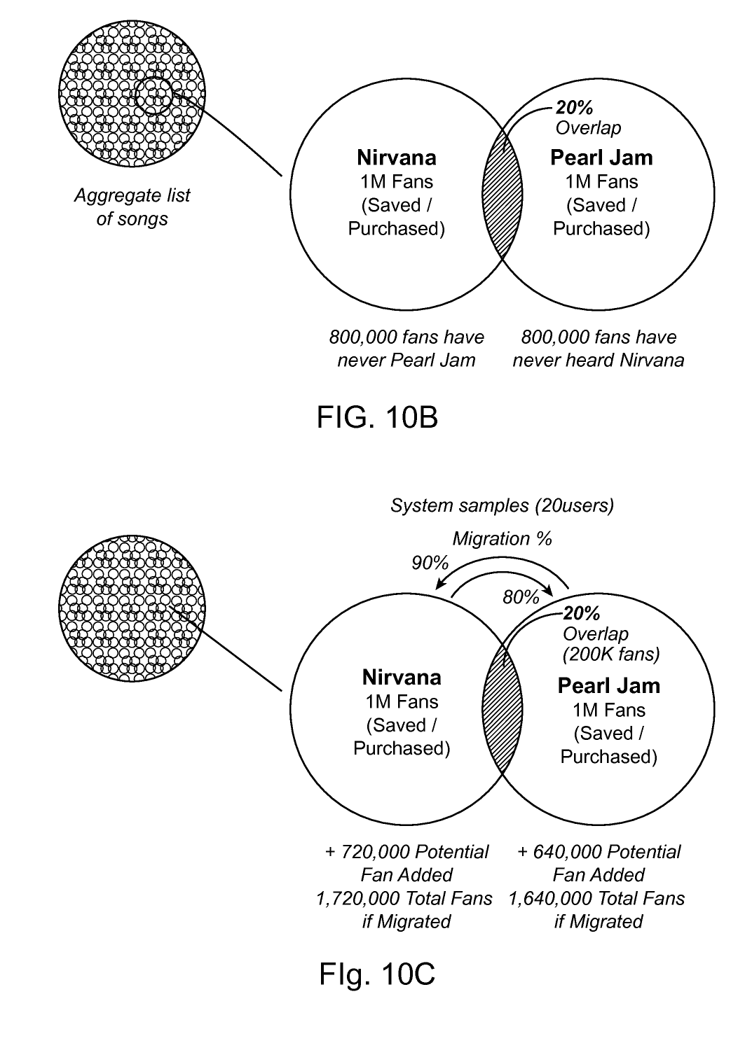

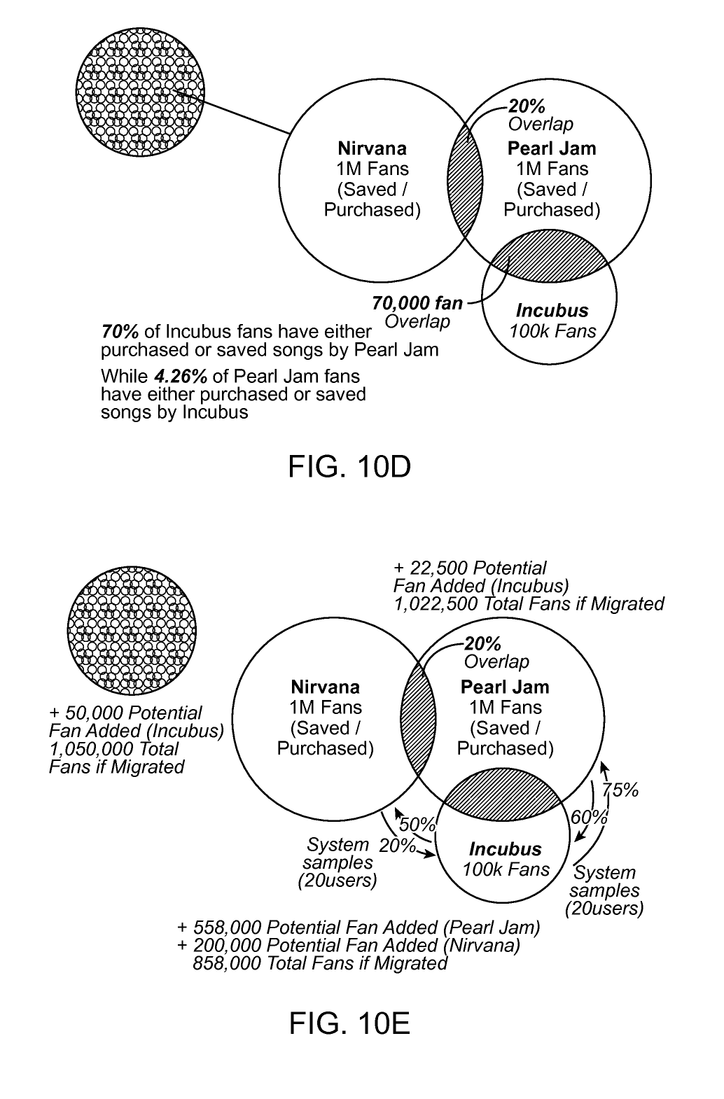

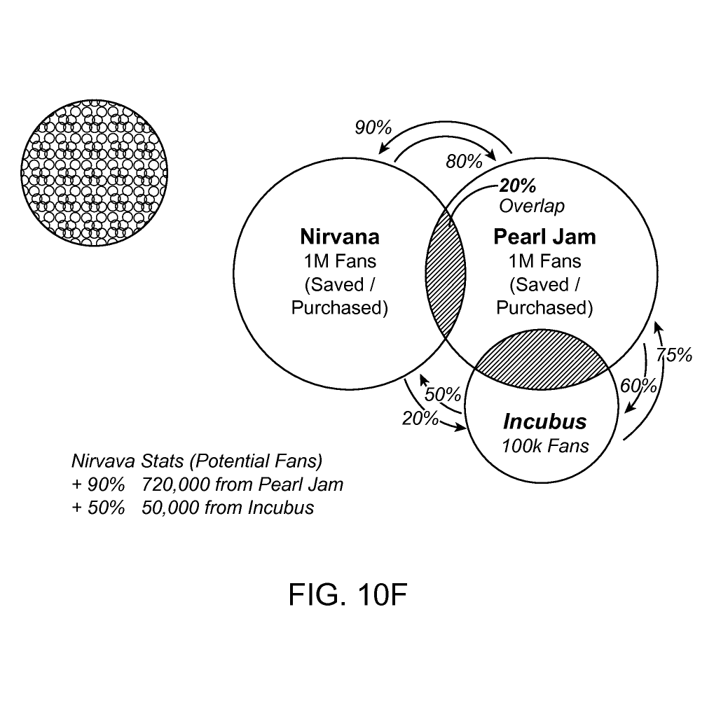

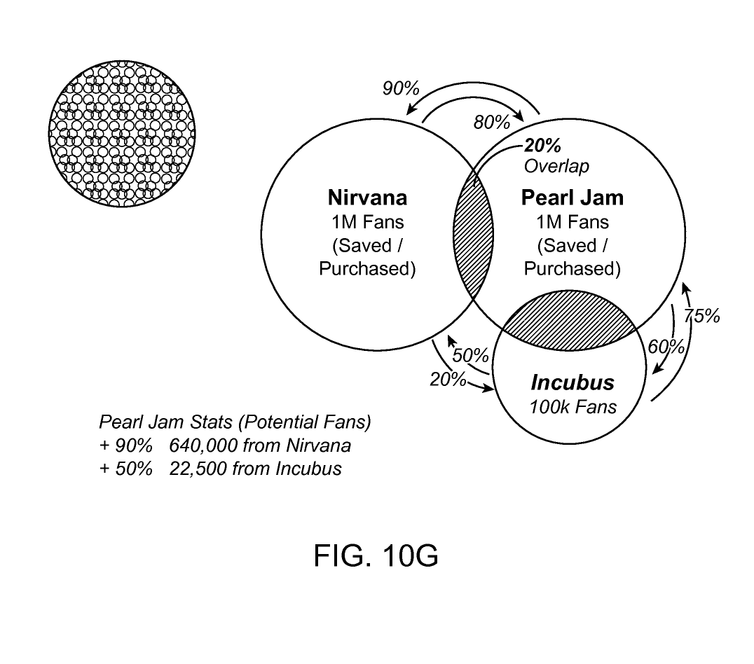

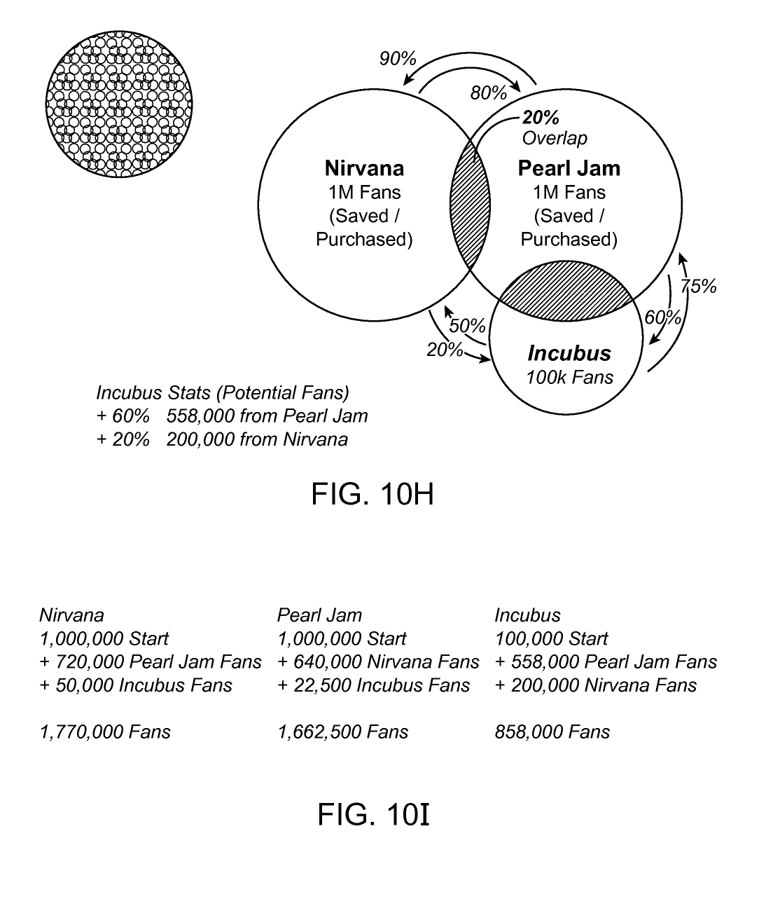

FIGS. 10A-10I illustrate a technique for determining a number of potential fans, using the system 10 of FIG. 1, in accordance with some embodiments. FIG. 10A illustrates a device 18 being used by an end user in a discovery mode, in which the end user may skip a song, save a song, enter an input to indicate that the user dislike a song, and/or to purchase a song. The input from the device 18 may be stored by the system 12, and may be analyzed by the system 12 to determine user(s) with similar music preference (e.g., 1000 users, or other number of users, with the most similar inputs), as similarly discussed with reference to item 208 in the method 200. The system 12 may then determine a recommendation list for the user (e.g., by aggregating list of songs), as similarly discussed with reference to item 210 in the method 200. Using this song recommendation technique, different music providers may gain additional fans from fan base of other music provider(s). Also, in some embodiments, the system 10 may provide a music provider an estimate of the potential fan base based on sampling a small number of users to which songs are recommended.

In the illustrated example shown in FIG. 10B, the music provider “Nirvana” has 1 million fans (e.g., individuals who have saved and/or purchased a music piece provided by Nirvana), and the music provider “Pearl Jam” has 1 million fans. 20% of the fans are overlap between Nirvana and Pearl Jam. That means there are 800 k fans for Nirvana that do not have songs from Pearl Jam, and there are 800 k fans for Pearl Jam that do not have songs from Nirvana. In some embodiments, the system 12 may access a list of fans for a first music provider (e.g., “Nirvana”). For example, the system 12 may access a database that stores the list of fans for the first music provider. The system 12 may then generate signal(s) for recommending a song from a second music provider (e.g., “Pearl Jam”) to a subset of the fans in the first list. The recommending of a song may be performed using the system 10 of FIG. 1, as similarly discussed with reference to item 204 in the method 200 described previously. In the illustrated example, the subset of the fans in the first list may be 20 users among the 800 k fans for Nirvana who do not have songs from Pearl Jam. In other examples, the subset (sample) of fans may be other values or percentages of the fans for Nirvana.

Next, the system 12 receives feedback regarding the recommended song (from Pearl Jam) from the subset (e.g., 20 individuals) of the fans in the first list. The act of receiving feedback may be performed as similarly discussed with reference to item 206 in the method 200 described previously. In the illustrated example, 16 users in the sample (who are fans of Nirvana) provide positive feedback (e.g., input indicating that the users like the song, saved the song, and/or purchased the song) regarding the recommended song from Pearl Jam. Since 80% of the users in the 20-user sample provided positive feedback, the system 12 may be configured to use this percentage to estimate the total number of fans from Nirvana that may potentially become fans of Pearl Jam. For example, the system 12 may multiply 800 k (which is the number of Nirvana fan who have not heard songs from Pearl Jam) by 80% (which is calculated by determining the portion of the user sample who provided positive feedback) to thereby arrive at the value of 640 k (which is the number of potential fans that may be gained by Pearl Jam through the system 10). This in turn, means that the number of total potential fans for Pearl Jam may be 1 million+640 k=1.64 million (as shown in FIG. 10C). In some embodiments, the system 12 may be configured to provide this projection to the music provider (e.g., Pearl Jam) to thereby allow the music provider to see the progress and the potential benefit of using the system 10.

Similarly, in the illustrated example, a sample (e.g., 20) of the fans of Pearl Jam may be provided with a recommended song by Nirvana using the system 10. In the illustrated example, 18 users in the sample provided positive feedback about the song by Nirvana. That means 90% of the 800 k Pearl Jam fans (which equal to 720 k fans) who have not heard the song by Nirvana may potentially become fans of Nirvana. This in turn, means that the number of total potential fans for Nirvana may be 1 million+720 k=1.72 million (as shown in FIG. 10C).

It should be noted that the number of music providers is not limited to two like that shown in the example, and that there may be more than two music providers in other embodiments. For example, as shown in FIGS. 10D, a third music provider (Incubus) with its own fan base may use the system 10 in the above example. As shown in the figure 70% of the Incubus fans have either purchased or saved songs by Pearl Jam. On the other hand, only 4.26% of Pearl Jam fans have either purchased or saved songs by Incubus. There are no overlapping fans between Nirvana and Incubus. In such cases, the system 10 may sample 20 users from the Nirvana fan base, and recommend a song from Incubus to this sample of 20 users (FIG. 10E). Based on feedback received from this sample of 20 users, the system 10 may then determine a percentage (50% in the illustrated example) of the sampled users who provided positive feedback, and may estimate a total number of fans (which is 50% times 100 k=50 k) from Incubus that may be gained by Nirvana using the system 10 (FIGS. 10E-10F).

Similarly, the system 10 may sample 20 users from the Pearl Jam fan base, and recommend a song from Incubus to this sample of 20 users (FIG. 10E). Based on feedback received from this sample of 20 users, the system 10 may then determine a percentage (75% in the example shown) of the sampled users who provided positive feedback, and may estimate a total number of fans (which is equal to (100 k-70 k)×0.75=22,500 fans) from Incubus that may be gained by Pearl Jam using the system 10 (FIGS. 10E and 10G). In particular, Incubus has 100,000 fans in which 70,000 already overlap with Pearl Jam (FIG. 10D) leaving a remaining 30,000 fans. 75% of the remaining 30,000 Incubus fans (30,000×0.75=22,500) successfully become fans to Pearl Jam.

Similarly, the system 10 may sample 20 users from the Incubus fan base, and recommend a song from Nirvana to this sample of 20 users (FIG. 10E). Based on feedback received from this sample of 20 users, the system 10 may then determine a percentage (20% in the example) of the sampled users who provided positive feedback, and may estimate a total number of fans (which is equal to 20% times 1 mil=200 k fans) from Nirvana that may be gained by Incubus using the system 10 (FIGS. 10E and 10H). Also, the system 10 may sample 20 users from the Incubus fan base, and recommend a song from Pearl Jam to this sample of 20 users (FIG. 10E). Based on feedback received from this sample of 20 users, the system 10 may then determine a percentage (60% in the example) of the sampled users who provided positive feedback, and may estimate a total number of fans (which is (1000 k−70 k)×0.6=558 k fans) from Pearl Jam that may be gained by Incubus using the system 10 (FIGS. 10E and 10H). In particular, Pearl Jam has 1,000,000 fans in which 70,000 already overlap with Incubus (FIG. 10D) leaving a remaining 930,000 fans. 60% of the remaining 930,000 Pearl Jam fans (which 930,000×0.60=558,000 fans) successfully become fans to Incubus.

FIG. 10I illustrates the number of total fans for the music providers Nirvana, Pearl Jam, and Incubus, determined by the system 10 using the above techniques.

In one or more embodiments described herein, the user interface 300 may optionally provide a graphic for allowing a user to buy or share music content. For example, after a song has been recommended to a user, and if a user has entered an input (e.g., by selecting the “like” button 320) to indicate that the user likes the song, the system 10 (e.g., the device 18 and/or the system 12) may allow the user to access the song a prescribed number of times (e.g., 3 times, 5 times, etc.). The system 10 (e.g., the device 18 and/or the system 12)) may be configured to keep track the number of times the user has accessed the song. For example, the system 10 may be configured to increment a count value by one every time the user accesses the same song. After the number of access for the song by the user has reached the prescribed number of times, the system 10 then prevents the user from access the song.

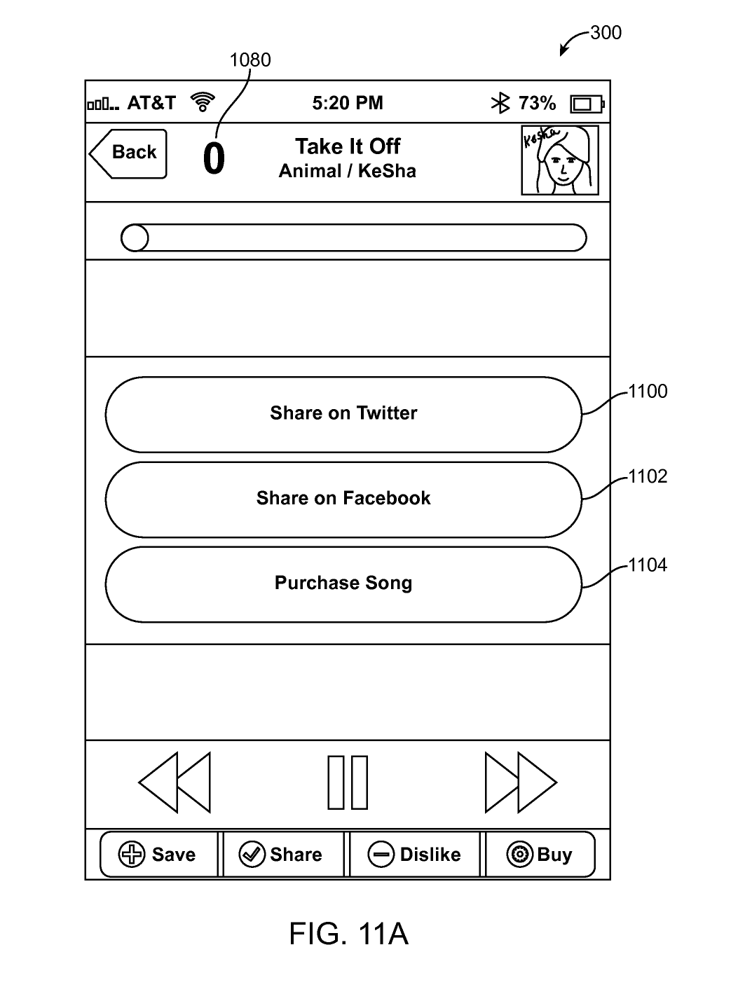

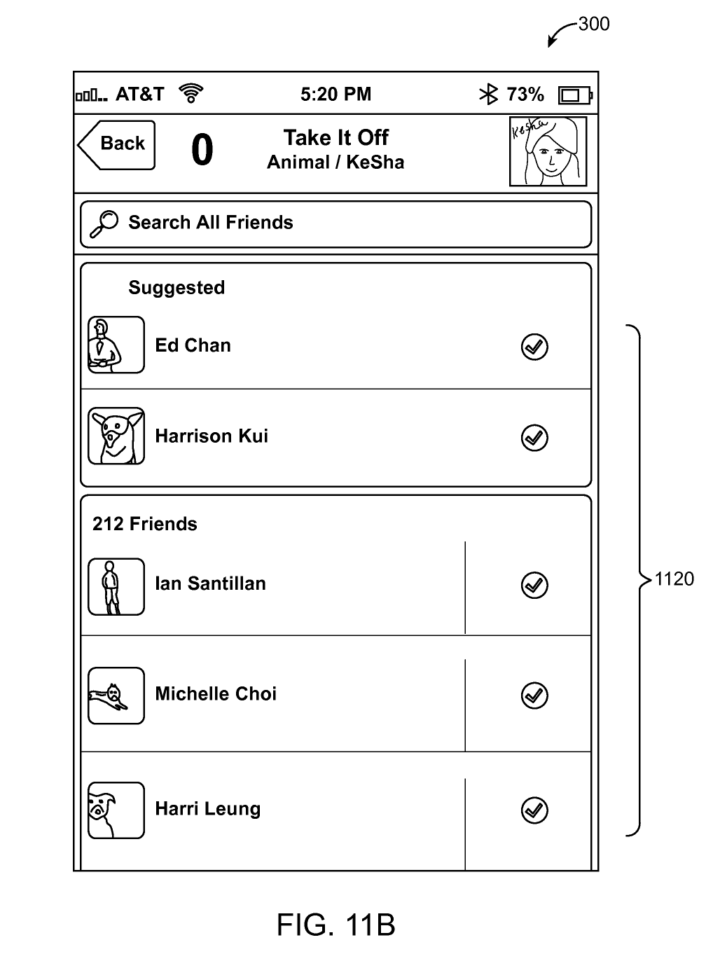

In some embodiments, when the system 10 determines that the number of access times has reached the prescribed number, the system 10 then provides a graphic in the user interface 300 to ask the user whether the user wishes to buy the song, or to share the song. FIG. 11A illustrates an example of the user interface 300 for display on the device 18, which allows a user of the device 18 to either share the song or to purchase the song, as different alternative ways to compensate for access of the song. As shown in the figure, the user interface 300 includes a count number 1080, which informs the user of the device 18 the remaining number of access for the song. When the count number 1080 has reached “0”, the user interface 300 then prompts the user to either share the song with a prescribed number of individuals, or to purchase the song. In the illustrated embodiments, the use interface 300 includes a button 1100 for allowing the user of the device 18 to share the song on Twitter, a button 1102 for allowing the user to share the song on Facebook, and a button 1104 for allowing the user to purchase the song. Although two sharing options are illustrated in the example, in other embodiments, there may be only one sharing option, or more than two sharing options. Also, in other embodiments, there may be other different types of sharing option. For example, in other embodiments, the user interface 300 may include a button for allowing the user of the device 18 to share the song by email, by text, etc.

In some embodiments, the user may select the share button (e.g., button 1100/1102). In such cases, the system 10 may then ask the user to identify a prescribed number of individuals for sharing the song. For example, if the user has selected the button 1102 for indicating a desire to share the song with Facebook users, the system 10 may then access the Facebook database to retrieve the Facebook users who are friends with the user, and may display the Facebook users' identifications 1120 in the user interface 300 on the device 18 (FIG. 11B). The system 10 may then ask the user of the device 18 to select a prescribed number (e.g., 3, 5, 10, etc.) of individuals for sharing the song. After the user of the device 18 has selected the individuals for sharing the song, the system 10 may then treat this action as a form of compensation by the user of the device 18 to the song provider. Accordingly, the system 10 may provide full access (e.g., unlimited access) of the song to the user of the device 18. Also, after the user of the device 18 has selected the individuals for sharing the song, the system 10 then recommends the song to the selected individuals. Each of the individuals who the user has identified for sharing the song may then go through the same process described above for experiencing the new song. For example, the individual may use his/her device 18 to experience the new song using the user interface 300, which is subject to the same restriction described above (e.g., the individual is allowed to access the song the prescribed number of times, and will then be prompted to select whether to share the song with other individuals or to purchase the song).

In other embodiments, after the user of the device 18 has selected the share button, instead of allowing the user to have full access of the song, the system 10 may allow the user to access the song again for a prescribed number of times. The prescribed number of times the second time around may be the same, or different from (e.g., fewer or more than) that in the first time. If the number of access has reached the prescribed number of times, the system 10 then prevents the user from accessing the song, and may prompt the user to either share the song again, or to purchase the song (e.g., by providing the user interface 300 of FIG. 11A again). The above process may be repeated until the user purchases the song. In some embodiments, the system 10 may be configured to keep track with the individuals to which the user has identified for sharing a particular song, and may prevent the user of the device 18 from sharing the same song to the same individual more than once.

In other embodiments, if the user of the device 18 does not wish to share the song, the user may then select the purchase button 1104. In such cases, the system 10 may then ask the user to provide purchase information (e.g., credit card number, Paypal account name, user identification, etc.) for making the purchase of the song. After the user has purchased the song, the system 10 then provides full access of the song for the user.

In the above embodiments, the count number 1080 represents a remaining number of access for a particular song. Thus, every song may have its own corresponding count number 1080 that is tracked by the system, depending on how much the user listen to the particular song. Also, in some embodiments, every song provider may set his/her own access limit for a particular song, and/or may set different access limits for different songs. For example, in some embodiments, a song provider may set the maximum access number for song A to be 5, and the maximum access number for song B to be 10. In addition, in other embodiments, instead of imposing a play access limitation on the user, the system 10 may be configured to impose other types of limitations. For example, in other embodiments, after the count number 1080 has reached “0”, the system 10 may impose a volume limit for the song (e.g., the system 10 may reduce the volume for the song). Furthermore, in other embodiments, the count number 1080 may be a time counter (for example, the value 1080 may represent a number of remaining months, remaining weeks, remaining days, remaining hours, etc., for which the user can access a particular song). In such cases, the system 10 is configured to keep track how much time has lapsed since a song has been recommended to a user. When the lapsed time has reached a limit, the system 10 then prompts the user to either share the song, or to purchase the song.

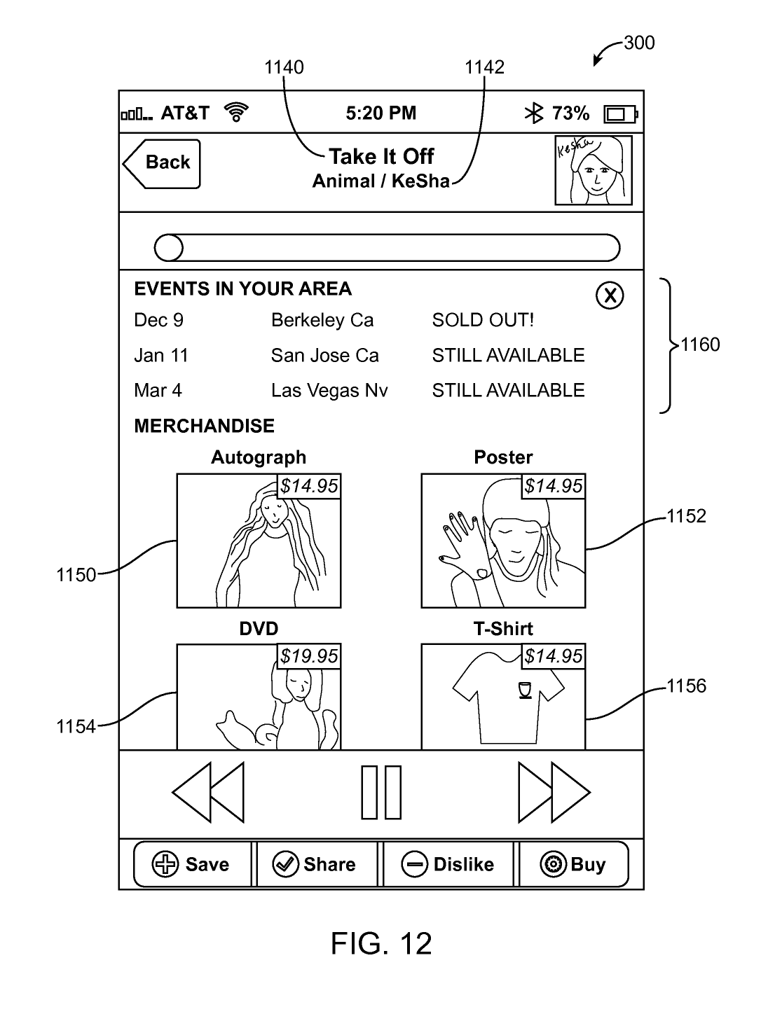

In one or more embodiments, when the user of the device 18 is playing a song, the user interface 300 may provide merchant information that is associated with the song or provider of the song. For example, as shown in FIG. 12, while the user of the device 18 is playing a song 1140 by KeSha 1142, the user interface 300 at the device 18 may display various merchandise information, such as an autograph item 1150 for allowing the user to purchase an autograph of the singer of the song that is being played, a poster item 1152 for allowing the user to purchase poster(s) of the singer of the song that is being played, a DVD item 1154 for allowing the user to purchase DVD(s) that includes the song being played or another song by the same singer, and a T-shirt item 1156 that allows the user to purchase T-shirt(s) having graphics of the singer or song provider. Also, in other embodiments, in addition to, or in the alternative to, the above items, the user interface 300 may provide other purchasable item(s), including but not limited to music piece(s) by the same singer or same music provider, music video(s) by the same singer or same music provider, and/or other physical merchandise, such as sticker(s), concert ticket(s), and/or clothing(s) that are the same or similar to those worn by the same singer. Also, as shown in the example of FIG. 12, the user interface 300 may also display events information 1160, such as concert dates, concert locations, and ticket information. In some embodiments, any of the merchandise information displayed on the user interface 300 may be selected by the user of the device 18, thereby allowing the user to make a purchase of the selected item. For example, in some embodiments, the user of the device 18 may select an event information. In response to the selection, the user interface 300 may then display information for allowing the user to buy a ticket for the event.

Various techniques may be employed to implement the merchant feature described above. In some embodiments, the system 12 may receive the merchant information from different merchants, and stores the merchant information in association with one or more songs. For example, a merchant who is selling a DVD may enter into the system 12 the singer or the song that is related to the DVD. The system 12 then stores the merchant information in association with the identified singer and/or the identified song. If a user of the device 18 plays the song (e.g., by accessing the system 12), the system 12 then pushes the associated merchant information for display on the device 18 through the user interface 300.

In other embodiments, the system 10 (e.g., the device 18 and/or the system 12) may store meta data for the merchant information together in association with the music content. For example, the device 18 may store meta data (e.g., a link to a merchant on-line store) regarding a particular merchant in association with a particular song. In such cases, whenever the user plays the song (which may be purchased or not) on the device 18, the device 18 then accesses the meta data to obtain the merchant information for display on the device 18.

It should be noted that in this specification, an action item being described as performed by the system 10 may be performed by the device 18, by the system 12, or by a combination of the device 18 and the system 12. For example, the action item may be performed by a processing unit (which may include hardware, software, or combination of both) in the device 18, a processing unit (which may include hardware, software, or combination of both) in the system 12, or both.

### Computer System Architecture

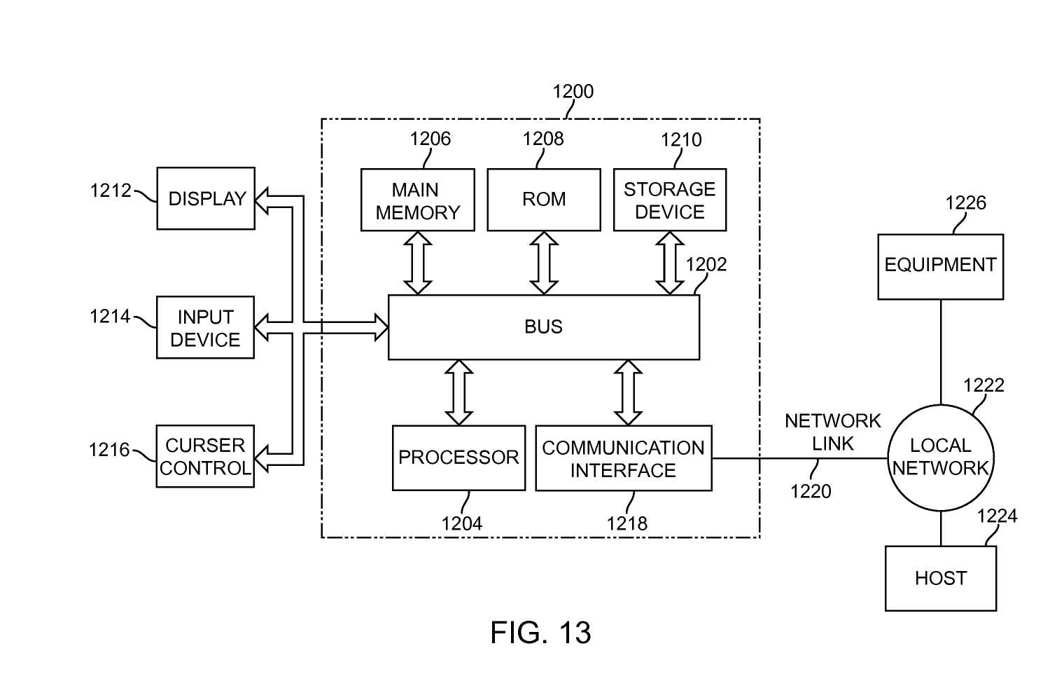

FIG. 13 is a block diagram that illustrates an embodiment of a computer system 1200 upon which embodiments of the features described herein may be implemented. In some embodiments, the computer system 1200 may be used to implement the system 12 of FIG. 1. In other embodiments, the computer system 1200 may be used to implement the device 18 of FIG. 1. In further embodiments, the computer system 1200 may be used to implement the device 24 used by the music provider in FIG. 1. Computer system 1200 includes a bus 1202 or other communication mechanism for communicating information, and a processor 1204 coupled with the bus 1202 for processing information. The processor 1204 may be configured to perform various functions described herein. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT) or a flat panel, for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform various processes described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media (an example of non-transitory media) includes, for example, optical or magnetic disks, such as the storage device 1210. Volatile media (another example of non-transitory media) includes dynamic memory, such as the main memory 1206. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments have been shown and described, it will be understood that they are not intended to limit the claimed inventions, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents.

1. (canceled)

2. A method of providing merchandise information, comprising:
providing music data of a music piece for reception by a user device;
providing music information for identifying the music piece; and
providing merchandise information, using a processing unit, for reception by the user device, wherein the merchandise information is associated with the music piece or with a provider of the music piece.

3. The method of claim 2, wherein the merchandise information, when displayed at the user device, is selectable using a user interface for allowing a user of the user device to purchase a merchandise associated with the merchandise information.

4. The method of claim 2, wherein the provider of the music piece is a singer, and the merchandise information comprises information regarding an autograph of the singer of the music piece, and the information regarding the autograph of the singer of the music piece is displayed at the user device in association with the music piece.

5. The method of claim 2, wherein the merchandise information comprises information regarding a poster, and the information regarding the poster is displayed at the user device in association with the music piece.

6. The method of claim 2, wherein the merchandise information comprises information regarding clothing, and the information regarding the clothing is displayed at the user device in association with the music piece.

7. The method of claim 2, wherein the merchandise information comprises information regarding a DVD, and the information regarding the DVD is displayed at the user device in association with the music piece.

8. The method of claim 2, wherein the merchandise information comprises information regarding a performance event, and the information regarding the event is displayed at the user device in association with the music piece.

9. The method of claim 2, wherein the merchandise information comprises concert information, and the concert information is displayed at the user device in association with the music piece.

10. The method of claim 9, wherein the concert information comprises concert date and concert location.

11. The method of claim 9, wherein the concert information comprises ticket information.

12. The method of claim 2, wherein merchandise information comprises a link to a merchant's on-line store.

13. The method of claim 2, wherein the acts of providing music data, providing music information, and providing merchandise information are performed by a remote device that is in communication with the user device, the remote device including the processing unit.

14. A system for providing music data for reception by a user device, comprising:
a processing unit having an input to receive a request for a music piece; and
one or more non-transitory media storing music data of the music piece, music information for identifying the music piece, and merchandise information associated with the music piece or with a provider of the music piece;
wherein the processing unit is configured to, in response to the request, access the music data, the music information, and the merchandise information from the one or more non-transitory media for providing the music data, the music information, and the merchandise information for the user device.

15. The system of claim 14, wherein the merchandise information, when displayed at the user device, is selectable using a user interface at the user device for allowing a user of the user device to purchase a merchandise associated with the merchandise information.

16. The system of claim 14, wherein the merchandise information comprises information regarding an autograph of a singer of the music piece, information regarding a poster, information regarding clothing, information regarding a DVD, or information regarding a performance event.

17. The system of claim 14, wherein merchandise information comprises a link to a merchant's on-line store.

18. A method of providing merchandise information, comprising:
receiving music data of a music piece at a user device;
receiving music information for identifying the music piece; and
receiving merchandise information at the user device, wherein the merchandise information is associated with the music piece or with a provider of the music piece.

19. The method of claim 18, wherein the merchandise information, when displayed at the user device, is selectable using a user interface at the user device for allowing a user of the user device to purchase a merchandise associated with the merchandise information.

20. The method of claim 18, wherein the provider of the music piece is a singer, and the merchandise information comprises information regarding an autograph of the singer of the music piece, and the information regarding the autograph of the singer of the music piece is displayed at the user device in association with the music piece.

21. The method of claim 18, wherein the merchandise information comprises information regarding a poster, and the information regarding the poster is displayed at the user device in association with the music piece.

22. The method of claim 18, wherein the merchandise information comprises information regarding clothing, and the information regarding the clothing is displayed at the user device in association with the music piece.

23. The method of claim 18, wherein the merchandise information comprises information regarding a DVD, and the information regarding the DVD is displayed at the user device in association with the music piece.

24. The method of claim 18, wherein the merchandise information comprises information regarding a performance event, and the information regarding the event is displayed at the user device in association with the music piece.

25. The method of claim 18, wherein the merchandise information comprises concert information, and the concert information is displayed at the user device in association with the music piece.

26. The method of claim 25, wherein the concert information comprises concert date and concert location.

27. The method of claim 25, wherein the concert information comprises ticket information.

28. The method of claim 18, wherein merchandise information comprises a link to a merchant's on-line store.

29. A user device capable of providing music for a user, comprising:
a screen;
an audio output;
a receiver to receive music data of a music piece, music information for identifying the music piece, and merchandise information associated with the music piece or with a provider of the music piece; and
a processing unit to process the music data for presentation of the music piece through the audio output, and to process the music information and the merchandise information for display at the screen.

30. The user device of claim 29, wherein the merchandise information, when displayed at the screen, is selectable by a user of the device to purchase a merchandise associated with the merchandise information.

31. The user device of claim 29, wherein the merchandise information comprises information regarding an autograph of a singer of the music piece, information regarding a poster, information regarding clothing, information regarding a DVD, or information regarding a performance event.

32. The user device of claim 29, wherein merchandise information comprises a link to a merchant's on-line store.
